(19) United States
(12) Patent Application Publication
(10) Pub. No.: US 2008/0100474 A1
(43) Pub. Date: May 1, 2008

(54) Flight information module

(75) Inventors: Rory G. Briski, Bellevue, WA (US); Steven R. Galipeau, Redmond, WA (US); Gregory P. Adams, Renton, WA (US)

Correspondence Address: Rory Briski, Suite B, 13200 SE 30th St., Bellevue, WA, 98005, US

(73) Assignee: Avion Engineering Services Inc. DBA Avion Partners, Bellevue, WA (US)

(21) Appl. No.: 11/974,088

(22) Filed: Oct. 11, 2007

Related U.S. Application Data
(60) Provisional application No. 60/851,231, filed on Oct. 12, 2006.

(51) Int. Cl. G08B 21/00

(52) U.S. Cl. 340/945

(57) ABSTRACT

A system for capturing flight information such as altitude and airspeed and displaying it in textual format to passengers and crew. Aircraft data is received, parsed and sent over a data network to be received and displayed at passenger seats, galleys and other convenient locations.

### BACKGROUND OF THE INVENTION

1. Field of the Invention

This invention relates to a system for capturing flight information such as altitude and airspeed and displaying it to a passenger or crew.

2. Description of Related/Prior Art

In many aircraft installations there are systems that receive the flight data information and translate it into a moving map image for display on video monitors within the aircraft cabin. However, if a movie or other video program is being shown when someone wants to know where they are, or have access to various aircraft parameters such as altitude or outside temperature, the passenger would need to either wait until the current video program is over or change the screen away from the movie and then change back. A bothersome disruption to them and to others located in the aircraft.

There are other products that provide for a dedicated display of either moving map or text but these require dedicated hardware to be purchased, certified by the Federal Aviation Administration as safe and then installed for just this single purpose.

With both weight and available space being critical within an aircraft environment, the above systems add needless weight and excess volume to an already crowded space.

Additionally, every box on an aircraft needs to go through extensive and costly testing to ensure its safe operation, and in the case of catastrophic failure, its inability to damage flight critical aircraft systems.

### OBJECTS AND AVANTAGES

Accordingly, several objects and advantages of our invention are:

Our Flight Information Module (FIM) can be integrated within an existing Cabin Management System hereby obviating the need for dedicated hardware.

Our FIM can be programmed in the field to display only those parameters that are of interest to the passenger or crew.

Our FIM can be programmed in the field as to how the display of the information is presented to the passengers and crew.

Our FIM can be programmed in the field as to what languages to display the information to the passengers and crew.

Further objects and advantages of our invention will become apparent from a consideration of the drawings and ensuing description.

### BRIEF SUMMARY OF INVENTION

The flight information module is essentially software that uses several existing pieces of hardware in the aircraft. The hardware interfaces to the aircraft flight management systems that contain the aircraft flight data of interest to the passengers and crew. This data is then passed along to a software parser which extracts the desired information, such as altitude, and this information is then multi-cast though the cabin management system data network for display onto passenger control units or other similar devices.

In other words, connecting to the ARINC429 or RS232 data bus and loading the FIM software will allow users to select Flight Information data on their passenger control unit (PCU). This data will function just like any other channel selection, except instead of tuning into Audio or Video, the PCU screen changes to a text readout where the various aircraft parameters are presented.

### DRAWINGS/LIST OF FIGURES

FIG. 1 Flight Information System Block Diagram

### DRAWINGS—LIST OF REFERENCE NUMBERS

| Item | Nomenclature |
|---|---|
| 101 | Cabin Management System |
| 102 | Media Encoder Unit |
| 103 | Avionics interface |
| 104 | FIM Processor and Multi-cast streamer |
| 105 | Receiving display device |
| 106 | Flight Management System |
| 107 | Air Data System |
| 108 | Off aircraft communications system |

### DETAILED DESCRIPTION

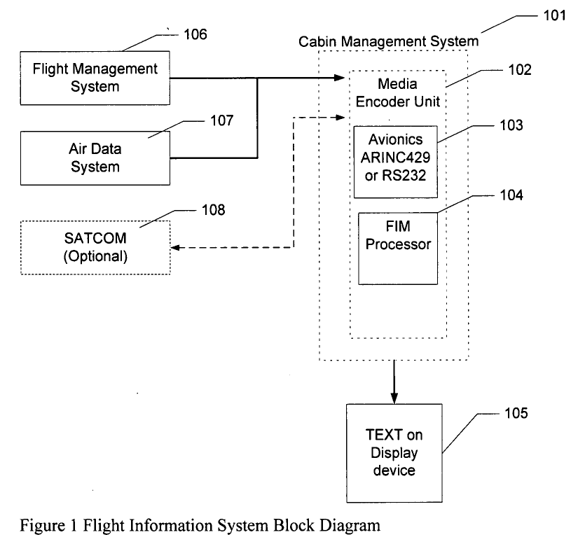

Please refer to FIG. 1.

In those installations where moving map information data such as time to destination, altitude, airspeed, etc. is desired, but there is either no video or the operator does not want to interrupt their video programming, or install dedicated hardware, this system provides a text only implementation using existing cabin management system hardware.

Within existing Cabin Management System 101 that has either an ARINC429 or RS232 data bus interface 103, this interface is connected to the Flight Management 106 or Air Data system 107 in order to receive the aircraft data.

Once the data is received by the data bus interface it is passed along to the Flight Information Module processor 104 where the data is parsed and then multi-case onto the aircraft cabin system data bus to be received at all applicable display devices 105 with names such as the passenger control unit or cabin switch panel or other similar device names. The display device 105 then formats the FIM data for presentation to the passenger as textual data.

What is claimed is:

1) A system that displays flight data as textual information onto a passenger control unit comprised of:
(a) an interface to flight management systems,
(b) a parser,
(c) a data processor,
(d) a data network
(e) one or more receivers located near one or more passengers,
(f) one or more displays located near one or more passengers.

2) The system in claim 1 where the data processor is also a multi-cast streamer.

3) The system in claim 2 where the data network is a multi-cast data network.

4) A system that displays flight data as textual information onto a cabin switch panel comprised of:
(a) an interface to flight management systems,
(b) a parser,
(c) a data processor,
(d) a data network
(e) one or more receivers located near one or more passengers,
(f) one or more displays located near one or more passengers.

5) The system in claim 4 where the data processor is also a multi-cast streamer.

6) The system in claim 5 where the data network is a multi-cast data network.
